(19) United States
(12) Patent Application Publication
(10) Pub. No.: US 2026/0112783 A1
(43) Pub. Date: Apr. 23, 2026

(54) PRISMATIC CELL

(71) Applicant: GM Global Technology Operations LLC, Detroit, MI (US)

(72) Inventors: Liang Xi, Northville, MI (US); Samir Orow, Sterling Heights, MI (US); Lei Wang, Rochester Hills, MI (US); SriLakshmi Katar, Troy, MI (US); Ryan Patrick Hickey, Austin, TX (US)

(21) Appl. No.: 18/919,959

(22) Filed: Oct. 18, 2024

(51) Int. Cl. H01M 50/51; H01M 50/209; H01M 50/249; H01M 50/289; H01M 50/569

(52) U.S. Cl. CPC H01M 50/51; H01M 50/209; H01M 50/249; H01M 50/289; H01M 50/569

(57) ABSTRACT

A vehicle includes at least one electric motor connected to an energy storage system. The energy storage system has a battery and an energy distribution controller. The battery includes a plurality of electrically connected prismatic cells. Each prismatic cell in the plurality of electrically connected prismatic cells includes a first energy storage component disposed in a housing and a second energy storage component disposed in the housing. The first energy storage component is electrically connected to the second energy storage component in a series connection. A positive terminal of the first energy storage component protrudes through the housing and a negative terminal of the second energy storage component protrudes through the housing.

The subject disclosure relates to high energy storage for battery cells, and in particular to improved packaging configurations for high voltage, large energy, prismatic cells.

Vehicles, including gasoline and diesel powered vehicles, as well as electric and hybrid electric vehicles, utilize battery storage to store electrical energy. The stored electrical energy powers electric motors, on board electronics and other vehicle subsystems during operation of the vehicle. Vehicle battery systems may be charged using exterior energy sources such as charging stations, other electric vehicle battery systems and/or an electrical grid. In some examples on board power generation systems may also provide electric energy to the battery storage.

Some vehicle battery systems store the electrical energy in a vehicle battery comprising a set of electrically connected energy cells (cells). In such examples, it can be desirable to increase a cell voltage and a cell power output in order to provide for more flexible packaging of the cells within the vehicle battery system and to reduce weight penalties and complexity associated with utilization of large numbers of cells.

### SUMMARY

In one exemplary embodiment a vehicle includes at least one electric motor connected to an energy storage system. The energy storage system has a battery and an energy distribution controller. The battery includes a plurality of electrically connected prismatic cells. Each prismatic cell in the plurality of electrically connected prismatic cells includes a first energy storage component disposed in a housing and a second energy storage component disposed in the housing. The first energy storage component is electrically connected to the second energy storage component in a series connection. A positive terminal of the first energy storage component extends through the housing and a negative terminal of the second energy storage component extends through the housing.

In addition to one or more of the features described herein the housing includes a plurality of distinct compartments and wherein each energy storage component is disposed in a unique one of the plurality of compartments.

In addition to one or more of the features described herein each compartment is separated from each other compartment.

In addition to one or more of the features described herein the series connection further comprises a sensor lead internal to the housing and a sensor connection exterior to the housing, and wherein the energy distribution controller includes a voltage sensor connected to the sensor connection and each of the positive terminal and the negative terminal, the voltage sensor providing a first sensed voltage differential output across the positive terminal and the series connection and a second sensed voltage differential output across the series connection and the negative terminal.

In addition to one or more of the features described herein the housing is a folded metal structure, and the plurality of distinct compartments are defined by at least one internal wall and interior surfaces of the housing with the at least one internal wall being welded to at least one interior surface of the housing.

In addition to one or more of the features described herein the housing is an extruded structure including exterior walls and a plurality of interior walls defining the plurality of distinct compartments.

In addition to one or more of the features described herein each energy storage component is electrically connected to the second energy storage component using a conductive bar connecting a negative terminal of the first energy storage component to a positive terminal of the second energy storage component.

In addition to one or more of the features described herein the conductive bar extends through an opening in an internal wall separating the first energy storage component and the second energy storage component.

In addition to one or more of the features described herein the prismatic cell further includes an electric insulator disposed between the opening in the internal wall and the conductive bar.

In addition to one or more of the features described herein the conductive bar, the negative terminal of the first energy storage component and the positive terminal of the second energy storage component are disposed within the housing.

In another exemplary embodiment a prismatic cell includes a housing having a base, a plurality of exterior walls extending from the base, at least one internal wall extending from the base and defining a plurality of compartments in conjunction with interior surfaces of the exterior walls, and a cap closing the plurality of compartments opposite the base. A first energy storage component is disposed in a first compartment of the plurality of compartments and a second energy storage component disposed in a second compartment of the plurality of compartments. The first energy storage component is electrically connected in series with the second energy storage component. The first energy storage component includes a positive terminal extending through the cap and the second energy storage component includes a negative terminal extending through the cap.

In addition to one or more of the features described herein the first compartment is separated from the second compartment.

In addition to one or more of the features described herein the first energy storage component is electrically connected to the second energy storage component via a conductive bar connecting a negative terminal of the first energy storage component to a positive terminal of the second energy storage component, and wherein the conductive bar, the negative terminal of the first energy storage component and the positive terminal of the second energy storage component are disposed in the housing.

In addition to one or more of the features described herein the conductive bar extends through an opening in an internal wall separating the first energy storage component and the second energy storage component.

In addition to one or more of the features described herein The prismatic cell further includes an electric insulator disposed between the opening in the internal wall and the conductive bar.

In addition to one or more of the features described herein the series connection further comprises sensor lead internal to the housing and providing a sensor connection exterior to the housing, and wherein the energy distribution controller includes a voltage sensor connected to the sensor connection and each of the positive terminal and the negative terminal, the voltage sensor providing a first sensed voltage differential output across the positive terminal and the series connection and a second sensed voltage differential output across the series connection and the negative terminal.

In addition to one or more of the features described herein the housing is a folded metal structure, and the at least one internal wall is welded to at least one interior surface of the housing.

In addition to one or more of the features described herein the housing is an extruded structure including exterior walls and a plurality of interior walls defining the plurality of distinct compartments.

In yet another exemplary embodiment a method for providing energy to a vehicle electrical system includes storing electric energy in a vehicle battery having a plurality of prismatic cells and an energy distribution controller. Each of the prismatic cells includes a first energy storage component disposed in a housing and a second energy storage component disposed in the housing, the first energy storage component being electrically connected to the second energy storage component in a series connection, and a positive terminal of the first energy storage component extending through the housing and a negative terminal of the second energy storage component extending through the housing. The method further includes controlling distribution of the electric energy from the vehicle battery to at least one electric powered vehicle system using an energy distribution controller.

In addition to one or more of the features described herein the first energy storage component is electrically connected to the second energy storage component via a conductive bar connecting a negative terminal of the first energy storage component to a positive terminal of the second energy storage component, and wherein the conductive bar, the negative terminal of the first energy storage component and the positive terminal of the second energy storage component are disposed in the housing.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a battery system;

FIG. 2 is an isometric view of a single cell of the battery system of FIG. 1 according to one example;

FIG. 3 is a top down view of the single cell of FIG. 2 in a first configuration;

FIG. 4 is a top down view of the single cell of FIG. 2 in a second configuration;

FIG. 5 is cross sectional view of a cell utilizing a first internal separation structure;

FIG. 6 is a cross sectional view of a cell utilizing a second internal separation structure; and

FIG. 7 is a cross sectional view of a cell utilizing a third internal separation structure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with a general embodiment, a vehicle battery system includes one or more prismatic energy storage cells (prismatic cells). The prismatic cells may be in multiple configurations and each of the prismatic cells includes a housing structure containing multiple internal energy storage components. The internal energy storage components are connected in series within the housing. A single positive terminal and a single negative terminal protrude from the housing of the prismatic cell.

The terminals extending from the housing of the prismatic cell provide a connection to external electrical systems. The multiple energy storage component structure with high energy density allows each prismatic cell to have a reduced pack mass due at least in part to decreased housing structure, an increased vent capacity for the housing, an increased pack voltage and power, and less housing surface area used to accommodate protruding terminals than comparable sets of prismatic cells with lower energy. In addition, the multiple energy storage component structure reduces overall cell complexity as the mechanical (structural) components remain the same on a per piece basis as single energy storage component designs, while providing higher cell energy.

The decreased proportion of the housing surface area required to facilitate terminals provides more flexibility in accommodating bus bars, electrical connections, and any other components within or around the vehicle battery system.

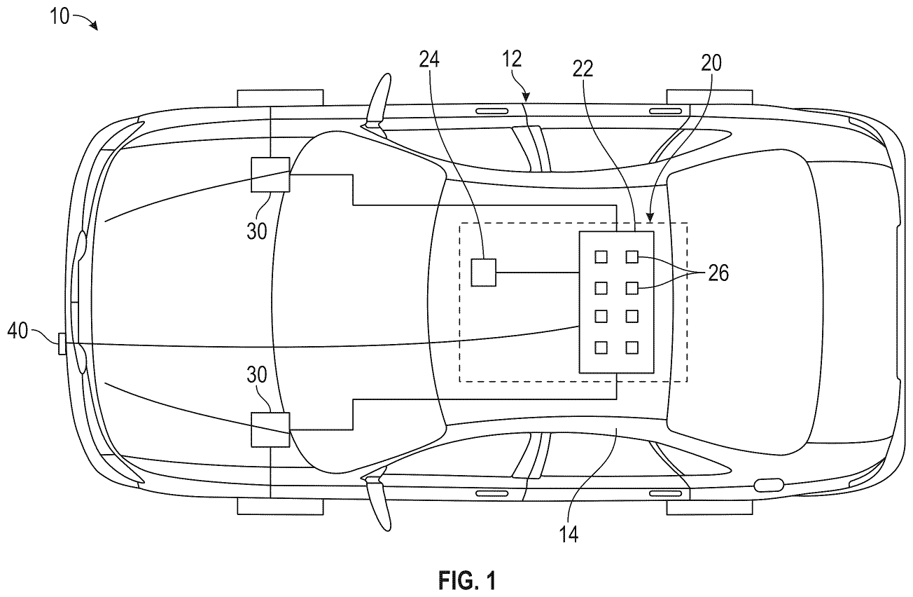

With continued reference to the exemplary general embodiment, FIG. 1 illustrates a vehicle 10 including a body 12 defining a passenger compartment 14.

The vehicle 10 includes an energy storage system 20 having a battery 22 and an energy distribution controller 24. The battery 22 includes multiple energy storage cells 26 (alternately referred to as cells 26) each of which stores electrical energy.

The cells 26 are electrically connected to each other within the battery 22. The cells 26 are physically arranged within the battery 22 according to packaging constraints. Due to the packaging constraints it is desirable to provide energy cells with a dense kilowatt-hour storage capacity, high voltage output, and flexible packaging configurations.

The energy distribution controller 24 controls the distribution of energy from the battery 22 to multiple drive motors 30 as well as any other vehicle systems configured to operate using battery 22 power. In addition, the energy distribution controller 24 controls a flow of energy from a charger 40 to the battery 22 when the charger 40 is connected to an external power source. In some examples, the energy distribution controller 24 can further control internal energy distribution between distinct cells 26, allowing for rebalancing of the energy between the cells 26; more particularized control over energy distribution to powered vehicle systems, reserving energy stored in one or more cells 26 as emergency energy, and similar energy controls.

Each cell 26 generally includes multiple series connected energy storage components contained within a housing. A positive electrical terminal and a negative electrical terminal extend from the energy storage components. Electrical leads or connections can be attached to the terminals providing access to the energy stored within the energy storage components.

In order to allow for more efficient assembly, maintenance, and packaging of the battery 22, the cells 26 are prismatic cells. A prismatic cell is a cell 26 whose energy storage components are enclosed in a rigid casing with the casing having dimensions configured for efficient packaging within a battery environment.

Prismatic cells typically include a rectangular shape which allows efficiently stacking of multiple cells 26 in a battery module, such as the battery 22. Each energy storage component includes a set of electrode sheets, an electrolyte fluid, and terminal connected to anode electrode sheets and cathode electrode sheets inside a casing. As used herein, the term energy component collectively refers to the electrode sheets (anode sheets, cathode sheets, and separator sheets), the electrolyte fluid and terminal connections to anode and cathode electrode sheets.

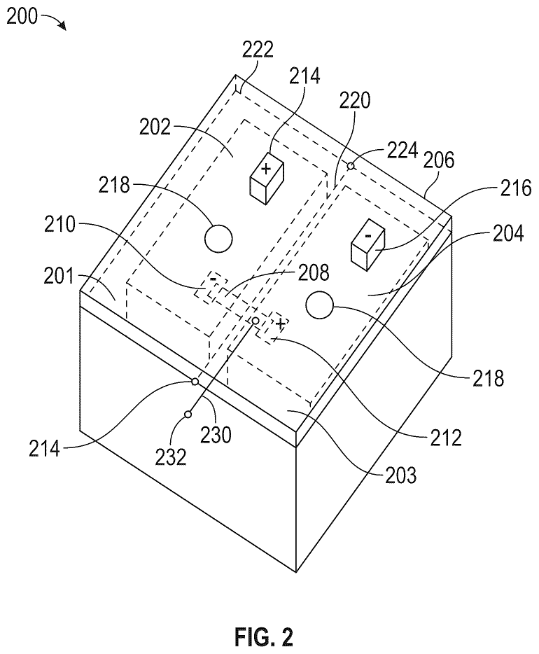

The cells 26 included in the battery system 22 are large energy cells (i.e., energy cells having a high energy density) with each cell 26 providing a dense energy storage. With continued reference to FIG. 1, FIG. 2 illustrates a single large energy cell 200 according to a first configuration. The large energy cell 200 provides an energy reserve greater than 0.7 kilowatt-hour (kWh) and significantly reduces materials required for packaging energy storage components 202, 204 by incorporating multiple energy storage components 202, 204 within a single housing 206. The large energy cell 200 refers to all features contained within and attached to the housing 206.

Inclusion of multiple chemical energy storage components 202, 204 within the single housing 206 reduces a materials used per kWh by decreasing the overall packaging requirements of a given cell 200. This in turn reduces the overall material requirements for all cells 26 within the battery system 22 and provides the same energy reserves as can be achieved in previous prismatic cell configurations with a lower weight penalty and a lower manufacturing and maintenance penalty.

Connecting the energy storage components 202, 204 in parallel within the housing 206 provides a similar energy reserve, but the large energy cell 200 is only capable of providing a voltage output of a single energy storage component 202, 204. In order to increase cell voltage, the large energy cell 200 connects the multiple energy storage cells 202, 204 in a series connection, with a negative terminal 210 of a first energy storage component 202 being connected to a positive terminal 212 of the second energy storage component 204 using a jump connection 208. While described herein generally as a jump bar, the jump connection 208 may be any type of electrical connection providing negligible resistance. The series connection allows a high voltage output of the large energy cell 200 in addition to the high energy capacity provided by the two energy storage components 202, 204.

In addition, due to the series connection a single positive terminal 214 (extending from the first energy storage component 202) and a single negative terminal 216 (extending from the second energy storage component 204) extend through the housing 206 to provide external electrical connections. This configuration can increase spacing between the external terminals 214, 216 and decreases a total percentage of the external surface area of the housing 206 that must be dedicated for electrical connections. The increased spacing and decreased percentage of surface area being used allows for more packaging flexibility. In addition, more distributed placement of vents 218 and inclusion of additional vents 218 can allow for more ideal pressure release from the packaging. Even further still, a reduced complexity of interfacing large energy cells 200 within the vehicle battery systems 22, and with other components of the vehicle 10 that may impact the packaging requirements of the battery system 22, can be achieved due to the decreased number of external terminals 214, 216.

Unlike parallel connected energy storage components, series connected energy storage components 202, 204 are susceptible to short circuit conditions where a short circuit inadvertently connects the two energy storage components 202, 204. To address this, each energy component 202, 204 is separated into corresponding compartments 201, 203 internal to the cell housing 206, with the compartment(s) being defined by an internal wall 220 and the walls of the housing 206. In examples where the housing 206 is created via a folding and welding process, the internal wall 220 is inserted into the housing 206 and welded to the internal surfaces of the housing 206 at multiple weld spots 224. In an alternative example, where the housing 206 is created via a material extrusion process, the internal wall 220 is extruded at the same time as the housing 206 resulting in a housing having a single unitary structure. In examples where more than two chemical energy storage components 202, 204 are included, additional internal walls 220 can be included as necessary to create a number of compartments at least equal to the number of energy storage components 202, 204.

The housing 206 includes a cap 222 enclosing the housing 206, with the external terminals 214, 216 extending through the cap 222. In the illustrated example of FIG. 2 the cap 222 includes vents 218 with at least one vent 218 corresponding to each distinct chemical energy storage component 202, 204 contained within the housing 206. In alternate examples, the vents 218 can be included at a base of the housing 206 instead of, or in addition to, vents 218 in the cap 222. In yet further examples, any other surface of the housing 206 may include vents 218 instead of, or in addition to the cap and base of the housing 206.

Disposed on the cap 222 is a monitor line 230. The monitor line 230 penetrates the cap 220 and contacts the jump connection 208. At an opposite end of the monitor line, a connection 232 is provided for connecting to a voltage sensor. By measuring a voltage differential between the positive external terminal 214 and the monitor line 230, or between the monitor line 230 and the negative external terminal 216, a controller 24 can independently monitor a voltage of each energy storage component 202, 204. In such an example the voltage differential between the positive external terminal 214 and the monitor line 230 corresponds to a voltage of the first energy storage component 202, and the voltage differential between the monitor line 230 and the negative external terminal 216 corresponds to a voltage of the second energy storage component 204. In a cell 26 including more than two series connected energy storage components, each jump connection will include a corresponding monitor line, and the voltage of any given energy storage component may be determined by a voltage across the jump connections and/or terminals of that particular energy storage component.

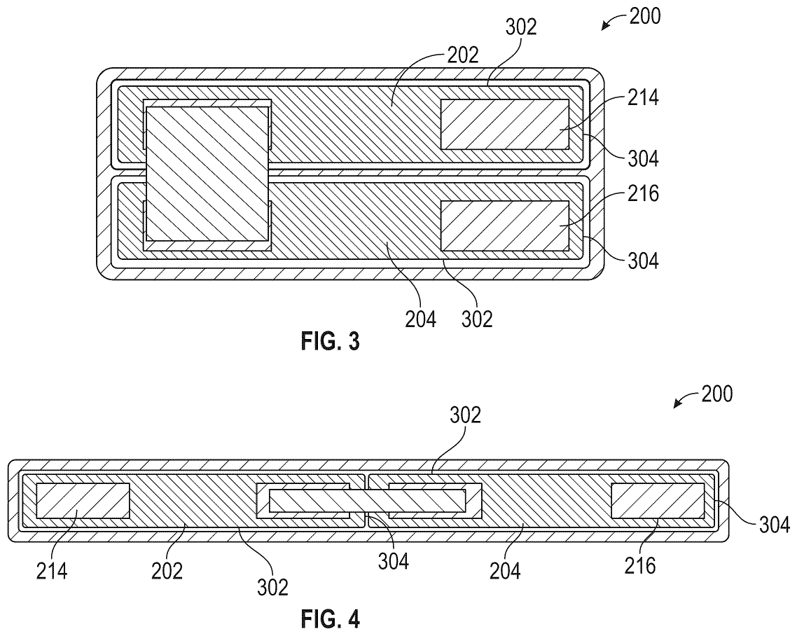

With continued reference to FIGS. 1 and 2, FIGS. 3 and 4 illustrate top down sectional views of alternate packaging arrangements for a large energy cell 200 where each chemical energy storage element 202, 204 is arranged adjacent to the other chemical energy storage element 202, 204 along either a side edge 302 (illustrated in FIG. 4) or an end edge 304 (illustrated in FIG. 3). In each configuration, a dimension of one of the edges 302, 304 remains the same as an energy cell including a single energy component 202, 204 while the dimension of the other edge 302, 304 is approximately twice the size of an example using a single energy component 202, 204.

In a given vehicle 10, the battery system 22 may incorporate large energy cells 200 in both the configuration of FIG. 3 and the configuration of FIG. 4, allowing multiple cells 26 having identical electrical characteristics to be packaged in spaces having different space allowances.

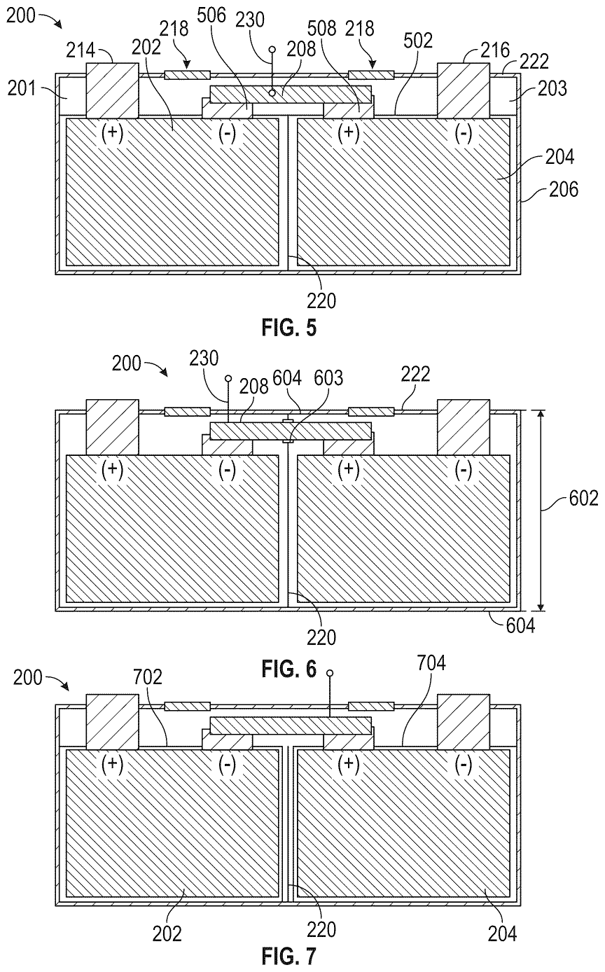

With continued reference to FIGS. 1-4, FIG. 5 illustrates a side cross sectional view of a first large energy cell 200. In the example large energy cell 200 of FIG. 5, each chemical energy storage component 202, 204 is separated into distinct compartments 201, 203 respectively with the compartments being defined by an interior wall 220. In addition, an internal cap 502 extends across the top of each chemical energy storage component 202, 204. The external terminals 214, 216 extend through the internal cap 502 and through the cap 222 closing the housing 206. The internal cap 502 is closed, and gasses from the energy storage components 202, 204 are able to flow through the internal cap 502 as further described herein. The gasses are allowed to escape the housing 206 through vents 218 disposed in the cap 222. In some examples, the internal cap 502 may include a weakened area, such as a dent or other structurally weak feature. The weakened area provides a break point where the cap 222 will fail in the case of excessive pressure buildup, thereby allowing for a controlled release of pressure buildup rather than release through an unknown and/or unexpected fault location. A terminal bar 208 connects internal terminals 506, 508 between the internal cap 502 and the cap 222.

With continued reference to FIGS. 1-5, FIG. 6 illustrates a cross sectional view of an alternate large energy cell 200 housing configuration, where the internal wall 220 extends a full height 602 of the cell 200 from a base 604 to the cap 222. While generally configured the same as the large energy cell 200 illustrated in FIG. 5, the large energy cell 200 of FIG. 6 omits the internal cap 502 with the terminal bar 208 extending through the internal wall 220. In order to prevent inadvertent electrification of the housing 206, or other types of short circuits, an insulator 606 is placed around the terminal bar 208 at a position where the terminal bar 208 passes through the internal wall 220. The insulator 604 can be a plastic, rubber, or similar non-conductive material able to be press fit into an opening in the internal wall 220 where the terminal bar 208 to passes through the opening.

With continued reference to FIGS. 1-6, FIG. 7 illustrates a third alternative, in which each of the chemical energy components 202, 204 is contained within a permeable non-conductive sealed pouch 702, 704. In one example, the sealed pouch 702, 704 is a polytetrafluoroethylene (PTFE) material which allows gasses to pass through the pouch 702, 704, but prevents liquid within the pouch 702, 704 from leaking. In the example of FIG. 7, the internal wall 220 extends less than the full height 602 of the large energy cell 200.

As with the configurations of FIGS. 3 and 4, a single vehicle battery 22 may include cells 26 having any combination of the characteristics of FIGS. 5-6, as well as any combination of the characteristics of FIGS. 3 and 4, with the particular combination of cell characteristics being determined by packaging constraints of the particular battery 22.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least one electric motor connected to an energy storage system;
the energy storage system having a battery and an energy distribution controller, wherein the battery is comprised of a plurality of electrically connected prismatic cells; and
each prismatic cell in the plurality of electrically connected prismatic cells comprising a first energy storage component disposed in a housing and a second energy storage component disposed in the housing, the first energy storage component being electrically connected to the second energy storage component in a series connection, and a positive terminal of the first energy storage component extending through the housing and a negative terminal of the second energy storage component extending through the housing.

2. The vehicle of claim 1, wherein the housing includes a plurality of compartments and wherein each energy storage component is disposed in a unique one of the plurality of compartments.

3. The vehicle of claim 2, wherein each compartment is separated from each other compartment.

4. The vehicle of claim 3, wherein the series connection further comprises a sensor lead internal to the housing and a sensor connection exterior to the housing, and wherein the energy distribution controller includes a voltage sensor connected to the sensor connection and each of the positive terminal and the negative terminal, the voltage sensor providing a first sensed voltage differential output across the positive terminal and the series connection and a second sensed voltage differential output across the series connection and the negative terminal.

5. The vehicle of claim 2, wherein the housing is a folded metal structure, and the plurality of distinct compartments are defined by at least one internal wall and interior surfaces of the housing with the at least one internal wall being welded to at least one interior surface of the housing.

6. The vehicle of claim 5, wherein the housing is an extruded structure including exterior walls and a plurality of interior walls defining the plurality of distinct compartments.

7. The vehicle of claim 1, wherein the first energy storage component is electrically connected to the second energy storage component using a conductive bar connecting a negative terminal of the first energy storage component to a positive terminal of the second energy storage component.

8. The vehicle of claim 7, wherein the conductive bar extends through an opening in an internal wall separating the first energy storage component and the second energy storage component.

9. The vehicle of claim 8, further comprising an electric insulator disposed between the opening in the internal wall and the conductive bar.

10. The vehicle of claim 7, wherein the conductive bar, the negative terminal of the first energy storage component and the positive terminal of the second energy storage component are disposed within the housing.

11. A prismatic cell comprising:
a housing including a base, a plurality of exterior walls extending from the base, at least one internal wall extending from the base and defining a plurality of compartments in conjunction with interior surfaces of the exterior walls, and a cap closing the plurality of compartments opposite the base;
a first energy storage component disposed in a first compartment of the plurality of compartments and a second energy storage component disposed in a second compartment of the plurality of compartments, the first energy storage component being electrically connected in series with the second energy storage component; and
the first energy storage component including a positive terminal extending through the cap and the second energy storage component including a negative terminal extending through the cap.

12. The prismatic cell of claim 11, wherein the first compartment is separated from the second compartment.

13. The prismatic cell of claim 11, wherein the first energy storage component is electrically connected to the second energy storage component via a conductive bar connecting a negative terminal of the first energy storage component to a positive terminal of the second energy storage component, and wherein the conductive bar, the negative terminal of the first energy storage component and the positive terminal of the second energy storage component are disposed in the housing.

14. The prismatic cell of claim 13, wherein the conductive bar extends through an opening in an internal wall separating the first energy storage component and the second energy storage component.

15. The prismatic cell of claim 14, further comprising an electric insulator disposed between the opening in the internal wall and the conductive bar.

16. The prismatic cell of claim 11, wherein the series connection further comprises sensor lead internal to the housing and a sensor connection exterior to the housing, and wherein the energy distribution controller includes a voltage sensor connected to the sensor connection and each of the positive terminal and the negative terminal, the voltage sensor providing a first sensed voltage differential output across the positive terminal and the series connection and a second sensed voltage differential output across the series connection and the negative terminal.

17. The prismatic cell of claim 11, wherein the housing is a folded metal structure, and the at least one internal wall is welded to at least one interior surface of the housing.

18. The prismatic cell of claim 11, wherein the housing is an extruded structure including exterior walls and a plurality of interior walls defining the plurality of distinct compartments.

19. A method for providing energy to a vehicle electrical system comprising:
storing electric energy in a vehicle battery comprising a plurality of prismatic cells and an energy distribution controller, wherein each of the prismatic cells includes a first energy storage component disposed in a housing and a second energy storage component disposed in the housing, the first energy storage component being electrically connected to the second energy storage component in a series connection, and a positive terminal of the first energy storage component extending through the housing and a negative terminal of the second energy storage component extending through the housing; and
controlling distribution of the electric energy from the vehicle battery to at least one electric powered vehicle system using an energy distribution controller.

20. The method of claim 19, wherein the first energy storage component is electrically connected to the second energy storage component via a conductive bar connecting a negative terminal of the first energy storage component to a positive terminal of the second energy storage component, and wherein the conductive bar, the negative terminal of the first energy storage component and the positive terminal of the second energy storage component are disposed in the housing.
